(19) United States
(12) Patent Application Publication
(10) Pub. No.: US 2026/0039071 A1
(43) Pub. Date: Feb. 5, 2026

(54) Connector For Direct Coaxial Cable To Substrate Termination

(71) Applicant: TE Connectivity Solutions GmbH, Schaffhausen (CH)

(72) Inventor: Francis John BLASICK, Halifax, PA (US)

(73) Assignee: TE Connectivity Solutions GmbH, Schaffhausen (CH)

(21) Appl. No.: 19/259,013

(22) Filed: Jul. 3, 2025

Related U.S. Application Data
(60) Provisional application No. 63/678,630, filed on Aug. 2, 2024.

(51) Int. Cl. H01R 24/50

(52) U.S. Cl. CPC H01R 24/50

(57) ABSTRACT

A connector assembly for mounting a coaxial cable to a substrate without the need of a separable interface. The connector assembly includes a housing having a cable receiving end and a substrate mating end. The cable receiving end is positioned in a first plane and the substrate mating end positioned in a second plane, the first plane being substantially transverse to the second plane. A cable receiving passage is positioned in the housing. The cable receiving passage extends from the cable receiving end. A center terminal extends through the substrate mating end. A conductor terminating portion of the center terminal extends into the cable receiving passage. The conductor terminating portion is configured to make a mechanical and electrical engagement with a center conductor of the coaxial cable.

### BACKGROUND OF THE INVENTION

The subject matter herein relates generally to coaxial cable connectors. In particular, the subject matter relates to a radio frequency (RF) connector which terminates a coaxial cable to a substrate, such as a printed circuit board (PCB), without the use of a separable interface.

Coaxial cable connectors are often complex and utilize costly manufacturing procedures. The individual parts are often assembled by several hand assembly steps to form the final connector. For example, conventional coaxial cables typically include a center conductor surrounded by an insulator. A conductive foil is disposed over the insulator and a cable braid surrounds the foil covered insulator. An outer insulative jacket surrounds the cable braid. In order to prepare the coaxial cable for termination, the outer jacket is stripped back exposing a portion of the cable braid. A portion of the insulator extends outwardly from the jacket. The insulator and outer conductor is stripped to expose a portion of the center conductor extending outwardly from the insulator. Upon assembly of a coaxial cable connector to the coaxial cable, the inner contact of the connector is coupled to the center conductor of the coaxial cable, such as by a crimped or a soldered connection, and the outer shell of the connector is coupled to the conductive cable braid, such as by a crimped or soldered connection, at the end of the coaxial cable. The process of preparing an end of a coaxial cable for installation into a connector requires a skilled operator and is time consuming.

As applied to connectors which terminate a coaxial cable to a printed circuit board, such connectors must be designed for multiple mating cycles. These connectors consume an excessive amount of space on and around the printed circuit boards. In addition, each interface located within the signal path of the transmission line degrades the electrical performance, and adds unnecessary cost to the termination.

It would, therefore, be beneficial to provide a connector which terminates a coaxial cable to a printed circuit board which is easy to assembly and which does not require the use of a separable interface, thereby reducing the space required on and around the printed circuit board and which improves the electrical performance and reduces cost.

### SUMMARY OF THE INVENTION

An embodiment is directed to a connector assembly for mounting a coaxial cable to a substrate without the need of a separable interface. The connector assembly includes a housing having a cable receiving end and a substrate mating end. The cable receiving end is positioned in a first plane and the substrate mating end positioned in a second plane, the first plane being substantially transverse to the second plane. A cable receiving passage is positioned in the housing. The cable receiving passage extends from the cable receiving end. A center terminal extends through the substrate mating end. A conductor terminating portion of the center terminal extends into the cable receiving passage. The conductor terminating portion is configured to make a mechanical and electrical engagement with a center conductor of the coaxial cable.

An embodiment is directed to a method of terminating a connector assembly for mounting a coaxial cable to a substrate without the need of a separable interface. The method include: mounting the connector assembly to a printed circuit board; inserting the cable with exposed center conductor into a portion of a housing the connector assembly; engaging the center conductor electrically with a center terminal of the connector assembly; engaging an outer conductive shield of the cable with a wall of the housing; securing the cable in the housing of the connector assembly; wherein the connector assembly terminates the cable to the printed circuit board without the use of a separable interface positioned on the cable.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a first illustrative embodiment of an RF connector assembly of the present invention.

FIG. 2 is an exploded perspective view of the connector assembly of FIG. 1.

FIG. 3 is a cross-sectional view of the connector assembly of FIG. 1, taken along a longitudinal axis of the connector assembly.

FIG. 4 is a perspective view of an access hood of the connector assembly of FIG. 1.

FIG. 5 is a cross-sectional view of a solder sleeve of the connector assembly of FIG. 1.

FIG. 6 is a perspective view of a center terminal of the connector assembly of FIG. 1.

FIG. 7 is a perspective view illustrating a first step in termination of a coaxial cable to the connector assembly of FIG. 1.

FIG. 8 is a perspective view illustrating a second step in termination of the coaxial cable to the connector assembly of FIG. 1.

FIG. 9 is a perspective view illustrating a third step in termination of the coaxial cable to the connector assembly of FIG. 1.

FIG. 10 is a perspective view illustrating a fourth step in termination of the coaxial cable to the connector assembly of FIG. 1.

FIG. 11 is a perspective view of the coaxial cable terminated to the RF connector assembly of FIG. 1.

FIG. 12 is a cross-sectional view of the terminate connector assembly of FIG. 11, taken along a longitudinal axis of the connector assembly.

FIG. 13 is a perspective view of a second illustrative embodiment of an RF connector assembly of the present invention.

FIG. 14 is an exploded perspective view of the connector assembly of FIG. 13.

FIG. 15 is a cross-sectional view of the connector assembly of FIG. 13, taken along a longitudinal axis of the connector assembly.

FIG. 16 is a perspective view of a bottom portion of the housing of the connector assembly of FIG. 13.

FIG. 17 is a perspective view of a top portion of the housing of the connector assembly of FIG. 13.

FIG. 18 is a perspective view of a compression sleeve of the connector assembly of FIG. 13.

FIG. 19 is a perspective view of a center terminal of the connector assembly of FIG. 13.

FIG. 20 is a perspective view illustrating a first step in termination of a coaxial cable to the connector assembly of FIG. 13.

FIG. 21 is a perspective view illustrating a second step in termination of the coaxial cable to the connector assembly of FIG. 13.

FIG. 22 is a perspective view illustrating a third step in termination of the coaxial cable to the connector assembly of FIG. 13.

FIG. 23 is a perspective view of the coaxial cable terminated to the RF connector assembly of FIG. 13.

FIG. 24 is a cross-sectional view of the terminated connector assembly of FIG. 23, taken along a longitudinal axis of the connector assembly.

### DETAILED DESCRIPTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

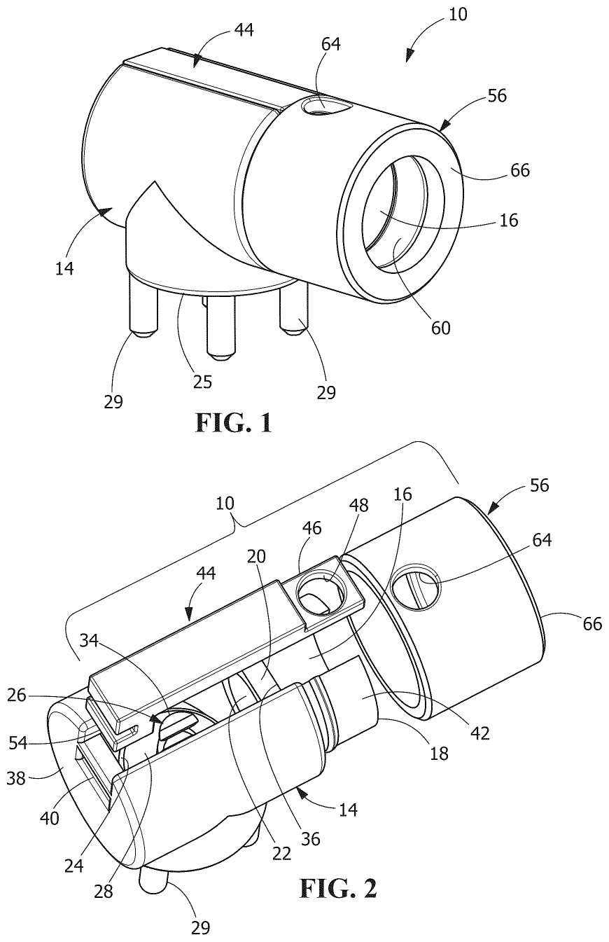

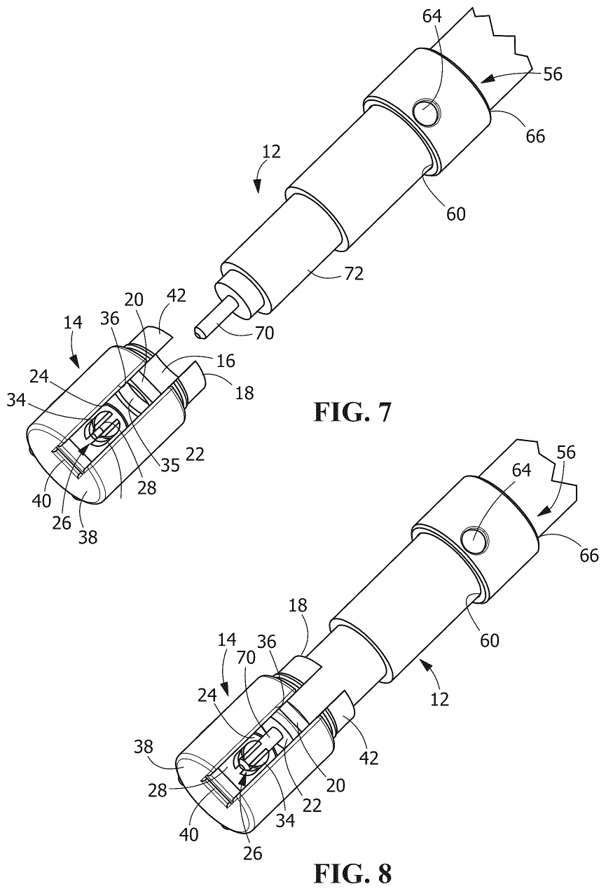

Referring to FIGS. 1 through 12, a first illustrative embodiment of an electrical connector assembly 10 of the present invention for terminating a coaxial cable 12 (FIGS. 7 through 12) to a printed circuit board (not shown) is shown. The connector assembly 10 has a housing 14, a removeable access hood 44, and a solder sleeve 56 which are which is made of electrically conductive material.

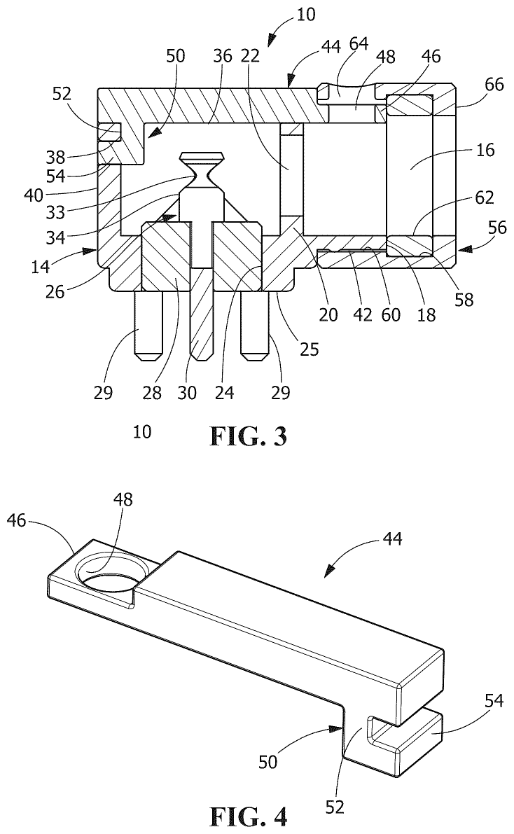

In the illustrative embodiment shown, the housing 14 has a generally cylindrical configuration with a cable receiving passage 16 which extends inward from a cable receiving end 18 of the housing 14. A cable positioning wall 20 (FIGS. 2 and 3) of the housing 14 extends into the cable receiving passage 16. A center conductor receiving opening 22 extends through the cable positioning wall 20.

A terminal receiving opening 24 extends through a substrate mating end 25 at a bottom portion of the housing 14. The substrate mating end 25 is positioned in a second plane which extends in a direction which is substantially transverse to a first plane in which the cable receiving end 18 is positioned. The terminal receiving opening 24 extends into the cable receiving passage 16. A center terminal 26 is positioned in the terminal receiving opening 24. A longitudinal axis of the terminal 26 is positioned essentially perpendicular to a longitudinal axis of the cable receiving passage 16. A dielectric insulator member 28 is positioned in the terminal receiving opening 24 to electrically insulate the terminal 26 from the housing 14.

Mounting legs 29 extend from the bottom portion of the housing 14. In the illustrative embodiment, the mounting legs 29 are configured to be positioned in through holes (not shown) of the printed circuit board and soldered in place. However, other types of mounting leg, including, but not limited to, press fit legs may be used. Alternatively, the mounting legs 29 may be soldered to the surface of the printed circuit board.

The terminal 26 (as shown in FIG. 6) has a circuit board mounting portion 30, a housing mounting portion 32 and a conductor terminating portion 34. In the illustrative embodiment shown, the conductor terminating portion 34 has a bifurcated configuration with a terminal receiving opening 33 and a slot 35 extending to the free end of the conductor terminating portion 34. However, other configurations of the terminal 26 and the conductor terminating portion 34 may be used.

A slot 36 extends through a top portion of the housing 14. The slot 36 extends into the cable receiving passage 16. The slot 36 is positioned to allow the center terminal 26 to be viewed during assembly of the connector assembly 10. In the illustrative embodiment shown, the slot 36 extends the entire length of the housing 14, from the cable receiving end 18 to a rear wall 38. A mounting opening 40 is positioned in the rear wall 38 proximate the slot 36.

A solder sleeve receiving section 42 is provided on the housing 14 at the cable receiving end 18. An inner diameter of the solder sleeve receiving section 42 is the same as the inner diameter of the housing 14, thereby allowing the cable receiving passage 16 to have a continuous surface. An outer diameter of the solder sleeve receiving section 42 is smaller than the outer diameter of the housing 14.

A removable access hood 44 (FIG. 4) is configured to be positioned in the slot 36. The access hood 44 is made of electrically conductive material and has a generally rectangular shape with a reduced thickness portion 46 provided at one end thereof. The reduced thickness portion 46 has an opening or viewport 48 which extends therethrough. A securing arm 50 is positioned at the opposite end of the access hood 44 from the reduced thickness portion 46. The securing arm 50 has a first section 52 which extends essentially perpendicular to the plane of the access hood 44. A second section 54 of the securing arm 50 extends essentially perpendicular to the first section 52. The second section 54 is configured to be positioned in the mounting opening 40.

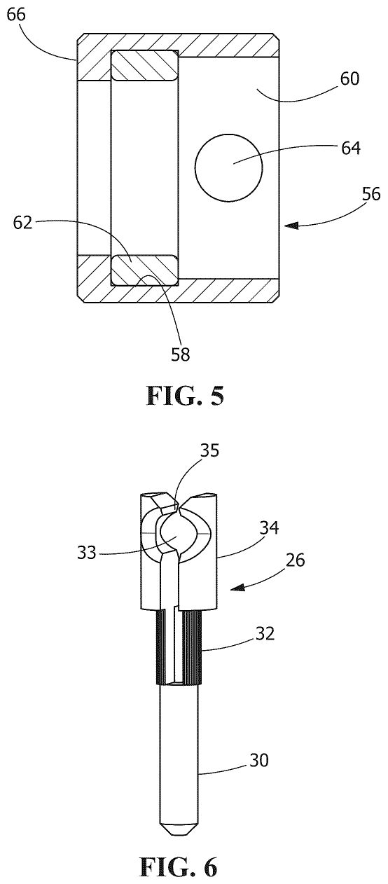

A solder sleeve 56 (FIG. 5) is configured to be positioned on the solder sleeve receiving section 42 of the housing 14. The solder sleeve 56 is made of electrically conductive material and has a generally cylindrical configuration. A solder receiving channel 58 extends about the circumference of the inner wall 60. The solder receiving channel has solder material 62 positioned therein. An opening or viewport 64 extends through the solder sleeve 56.

With reference to FIGS. 7 through 12, the method of assembly of the connector assembly 10 will be described. The housing 14 is fixed to the printed circuit board (not shown). The housing 14 may be fixed using solder, press fit or other known methods to fix a housing to a printed circuit board. As shown in FIG. 7, the coaxial cable 12 has been prepared to expose the center conductor 70 and the outer shield member 72. The solder sleeve 56 is preassembled or positioned over the cable 12 and is movable relative to the longitudinal axis of the cable 12.

The exposed end of the cable 12 is moved into the cable receiving passage 16 of the housing 14. As insertion of the cable 12 into the cable receiving passage 16 occurs, the center conductor 70 is moved into mechanical and electrical engagement with the conductor terminating portion 34 of the terminal 26. The center conductor 70 may be moved into electrical engagement with the terminal 26 by any known method. In the illustrative embodiment, the center conductor 70 may be inserted directly into the terminal receiving opening 33 or the center conductor 70 may be inserted into the terminal receiving opening by moving the center conductor 70 through the slot 35 and into the terminal receiving opening 33.

Insertion of the cable 12 continues until the end of the outer shield member 72 engages the cable positioning wall 20. In this position, as shown in FIG. 8, the center conductor 70 is in electrical engagement with the terminal 26 and the outer shield member 72 is in electrical engagement with the cable positioning wall 20 and the housing 14. The slot 36 enables the user to properly view the terminal 26 and the center conductor 70 to ensure that the center conductor 70 is properly terminated to the terminal 26.

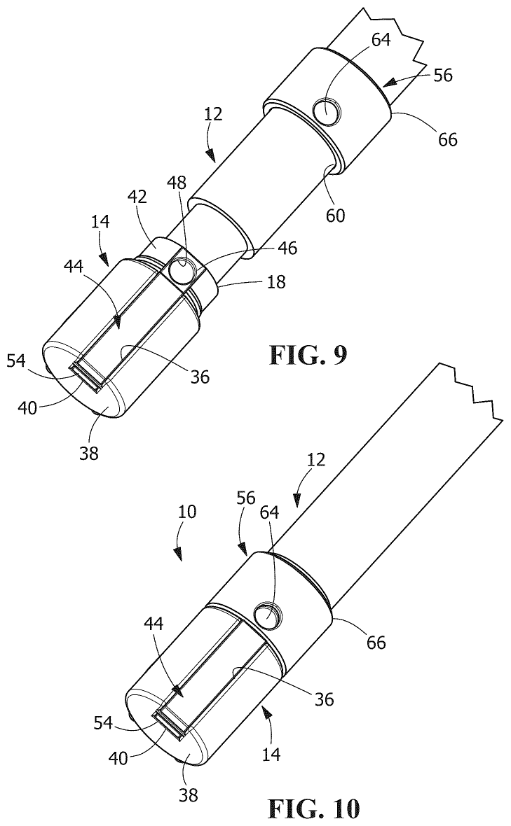

With the cable 12 properly positioned in the housing 14, the removable access hood 44 is positioned in the slot 36. As shown in FIG. 9, the second section 54 of the securing arm 50 is positioned in the mounting opening 40 of the housing 14 to maintain the access hood 44 in the slot 36.

With the access hood 44 properly positioned, the solder sleeve 56 is moved into position over the solder sleeve receiving section 42 of the housing 14, as shown in FIG. 10. When properly positioned, the opening or viewport 64 of the solder sleeve 56 is aligned with the opening or viewport 48 of the access hood 44.

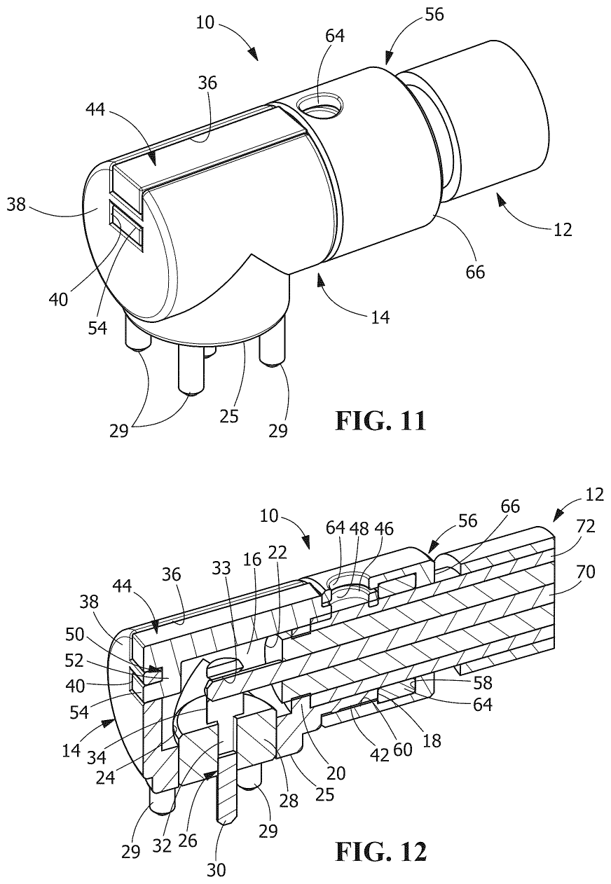

With the components of the connector assembly 10 properly positioned (as shown in FIGS. 11 and 12), heat is applied to proximate a back edge 66 of the solder sleeve 56. The heat applied must be sufficient to allow the solder to flow while not damaging any of the components of the connector assembly 10. The heat may be applied by a solder gun or other methods. The viewport 64 of the solder sleeve 56 and the opening or viewport 48 of the access hood 44 allow the user to visually confirm soldering wetting, thereby confirming that the solder has flowed properly.

The connector assembly 10 terminates the coaxial cable 12 to a printed circuit board without the need of a separable interface on the coaxial cable 12, thereby reducing the space required on and around the printed circuit board and improving the electrical performance while reducing cost. In addition, the connector assembly 10 can be disassembled and reassembled to allow for repair or replacement of the cable.

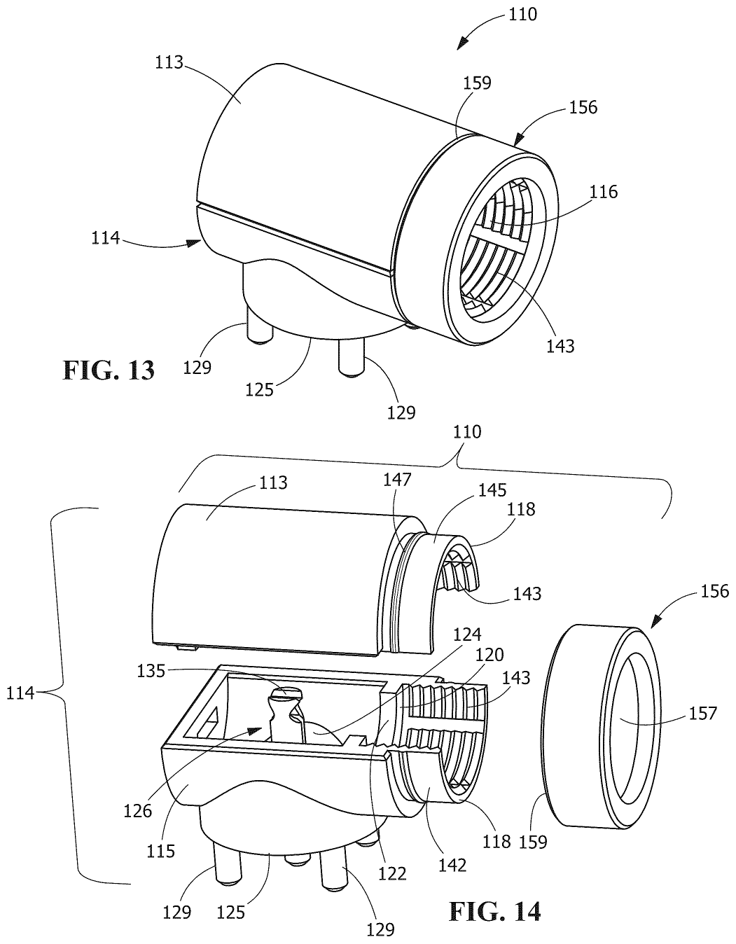

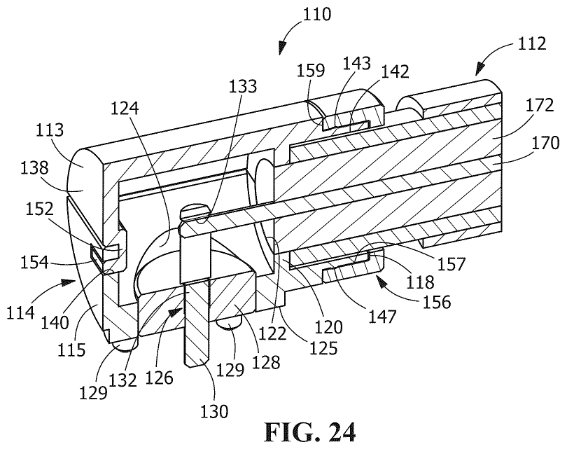

Referring to FIGS. 13 through 24, a second illustrative embodiment of an electrical connector assembly 110 of the present invention for terminating a coaxial cable 112 (FIGS. 7 through 12) to a printed circuit board (not shown) is shown. The connector assembly 110 has a housing 114 which is made of electrically conductive material.

In the illustrative embodiment shown, the housing 114 has a first housing portion 113 and a second housing portion 115. When the portions 113, 115 are mated together, the housing 114 has a generally cylindrical configuration with a cable receiving passage 116 which extends inward from a cable receiving end 118 of the housing 114. A cable positioning wall 120 (FIGS. 14 through 17) of the housing 114 extends into the cable receiving passage 116. A center conductor receiving opening 122 extends through the cable positioning wall 120.

A terminal receiving opening 124 extends through a substrate mating end 125 on the second portion 115 of the housing 114. The substrate mating end 125 is positioned in a second plane which extends in a direction which is substantially transverse to a first plane in which the cable receiving end 118 is positioned. The terminal receiving opening 124 extends into the cable receiving passage 116. A center terminal 126 is positioned in the terminal receiving opening 124. A longitudinal axis of the terminal 126 is positioned essentially perpendicular to a longitudinal axis of the cable receiving passage 116. A dielectric insulator member 128 is positioned in the terminal receiving opening 124 to electrically insulate the terminal 126 from the housing 114.

Mounting legs 129 extend from the second portion 115 of the housing 114. In the illustrative embodiment, the mounting legs 129 are configured to be positioned in through holes (not shown) of the printed circuit board and soldered in place. However, other types of mounting leg, including, but not limited to, press fit legs may be used.

The terminal 126 (as shown in FIG. 19) has a circuit board mounting portion 130, a housing mounting portion 132 and a conductor terminating portion 134. In the illustrative embodiment shown, the conductor terminating portion 134 has a tuning fork or bifurcated configuration with a terminal receiving opening 133 and a slot 135 extending to the free end of the conductor terminating portion 134. However, other configurations of the terminal 126 and the conductor terminating portion 134 may be used.

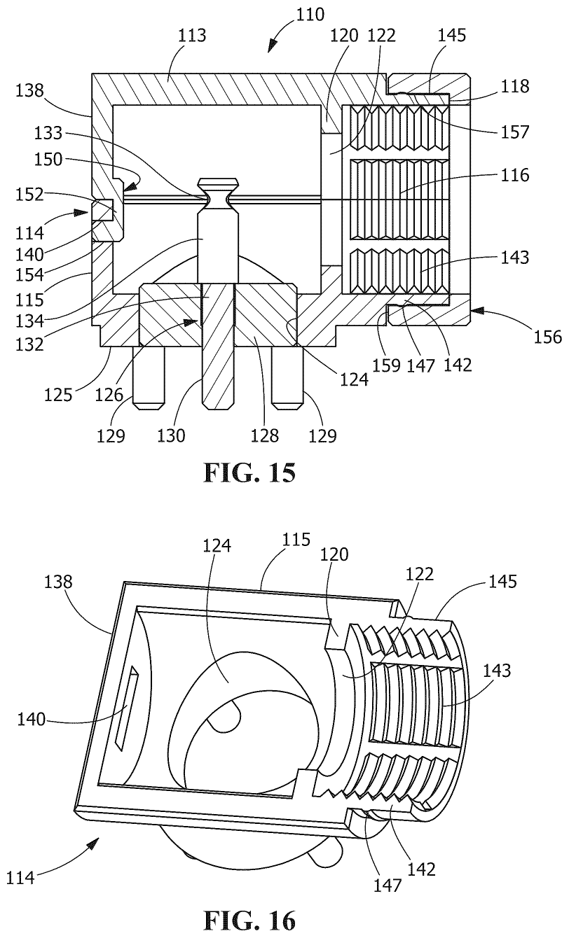

As shown in FIGS. 15 through 17, a compression sleeve receiving section 142 is provided on the housing 114 at the cable receiving end 118. An inner diameter of the solder sleeve receiving section 142 is essentially the same as the inner diameter of the housing 114, thereby allowing the cable receiving passage 116 to have a continuous surface. An outer diameter of the solder sleeve receiving section 142 is smaller than the outer diameter of the housing 114. The compression sleeve receiving section 142 has internal broached ribs or grip ribs 143 which extend about the inner surface of the compression sleeve receiving section 142. An outer surface 145 of the compression sleeve receiving section 142 is tapered, with the portion of the compression sleeve receiving section 142 proximate the cable receiving end 118 having a smaller diameter than the portion of the compression sleeve receiving section 142 which is spaced from the cable receiving end 118. A retention projection 147 extends from the outer surface 145 in a direction away from the cable receiving passage 116.

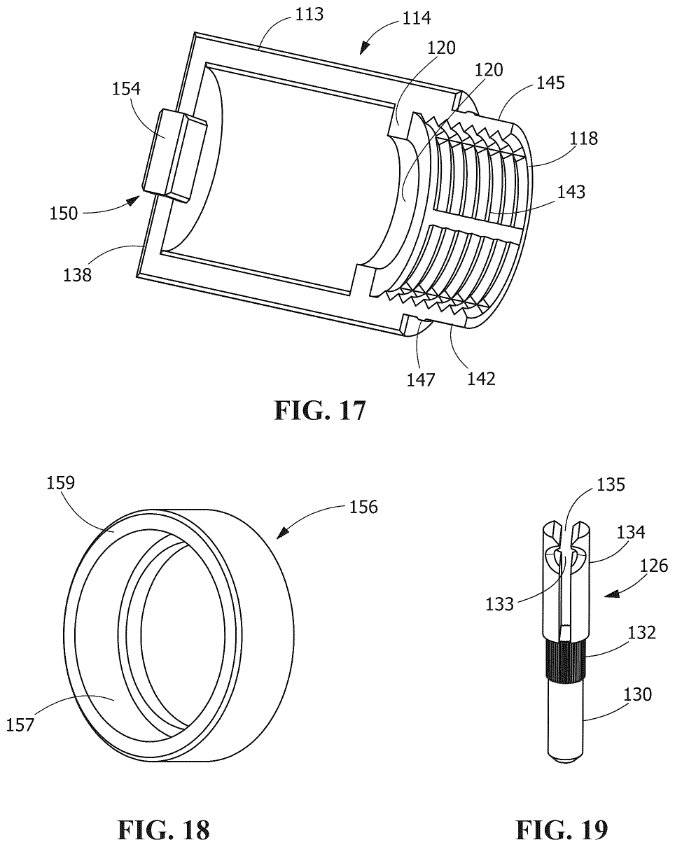

As shown in FIG. 17, a securing arm 150 extends from the first portion 113 of the housing 114 proximate a rear wall 138 of the housing 114. The securing arm 150 has first section 152 which extends from the first portion 113. A second section 154 of the securing arm 150 extends essentially perpendicular to the first section 152. The second section 154 is configured to be positioned a mounting opening 140 positioned in the rear wall 138 of the second portion 115 of the housing 114 (FIG. 16).

A compression sleeve 156 (FIG. 18) is configured to be positioned on the compression sleeve receiving section 142 of the housing 114. The compression sleeve 156 has a generally cylindrical configuration. An inner surface 157 of the compression sleeve 156 is tapered, with the portion of the compression sleeve 156 proximate a leading edge 159 having a larger diameter than the portion of the compression sleeve 156 which is spaced from the leading edge 159.

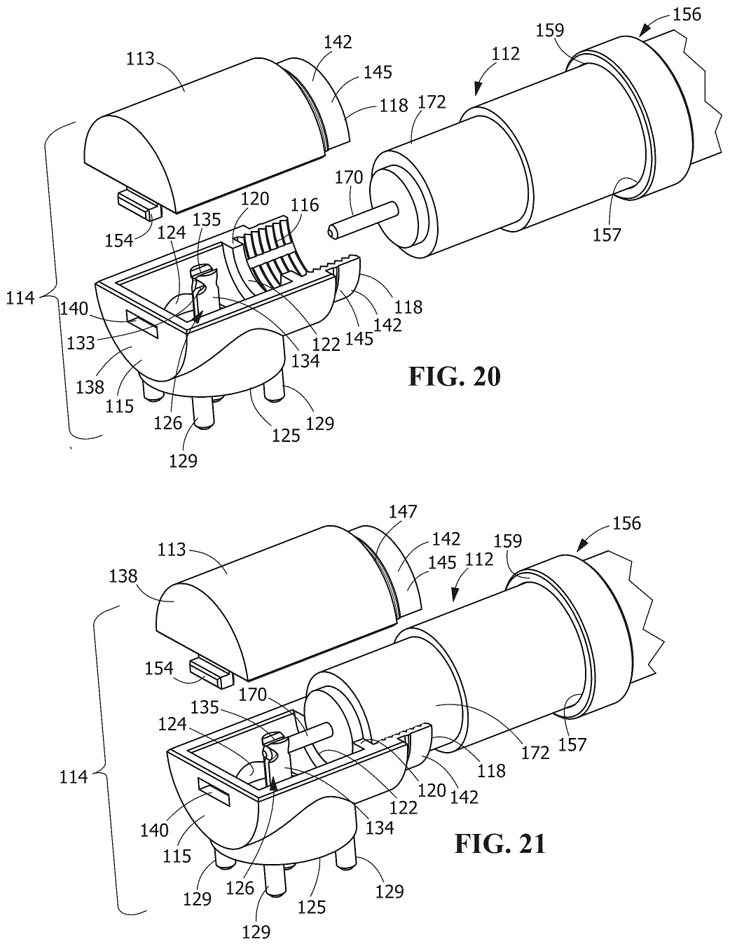

With reference to FIGS. 20 through 24, the method of assembly of the connector assembly 110 will be described. As shown in FIG. 20, the coaxial cable 112 has been prepared to expose the center conductor 170 and the outer shield member 172. The compression sleeve 156 is preassembled or positioned over the cable 112 and is movable relative to the longitudinal axis of the cable 112.

The exposed end of the cable 112 is moved into the cable receiving passage 116 of the second portion 115 of the housing 114. As insertion of the cable 112 into the cable receiving passage 116 occurs, the center conductor 170 is moved into mechanical and electrical engagement with the conductor terminating portion 134 of the terminal 126. The center conductor 170 may be moved into electrical engagement with the terminal 126 by any known method. In the illustrative embodiment, the center conductor 170 may be inserted directly into the terminal receiving opening 133 or the center conductor 170 may be inserted into the terminal receiving opening by moving the center conductor 170 through the slot 135 and into the terminal receiving opening 133.

Insertion of the cable 112 continues until the end of the outer shield member 172 engages the cable positioning wall 120 of the second portion 115 of the housing 114. In this position, as shown in FIG. 21, the center conductor 170 is in electrical engagement with the terminal 126 and the outer shield member 172 is in electrical engagement with the cable positioning wall 120 and the housing 114. As the first portion 113 of the housing 114 is not in position, the user can properly view the terminal 126 and the center conductor 170 to ensure that the center conductor 170 is properly terminated to the terminal 126.

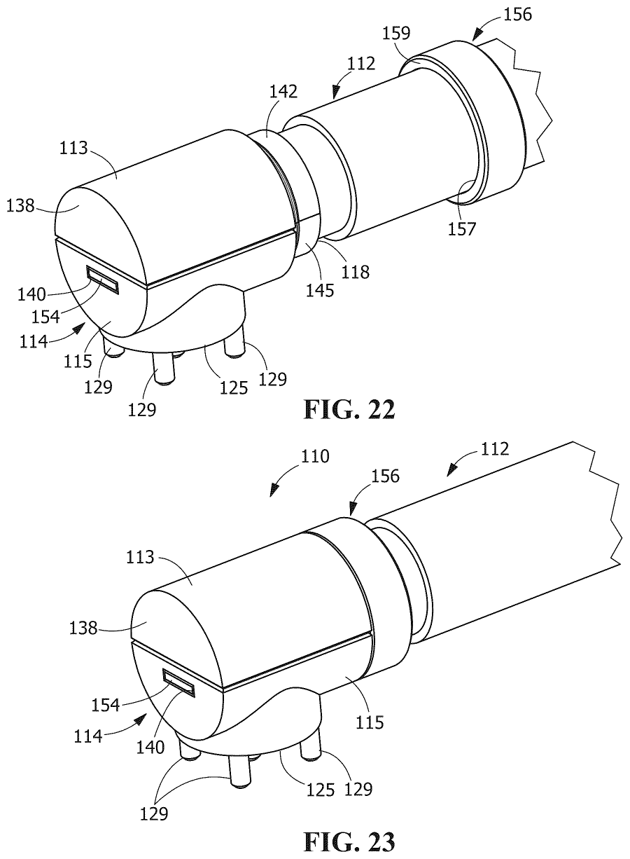

With the cable 112 properly positioned in the housing 114, the first portion 113 of the housing 114 is moved into engagement with the second portion 115 of the housing 114. As shown in FIG. 22, the second section 154 of the securing arm 150 of the first portion 113 of the housing 114 is positioned in the mounting opening 140 of the second portion 115 of the housing 114 to maintain the first portion 113 in position relative to the second portion 115.

With the first portion 113 properly positioned, the compression sleeve 156 is moved into positioned over the compression sleeve receiving section 142 of the housing 114, as shown in FIG. 23. As this occurs, the tapered inner surface 157 of the compression sleeve 156 engages the tapered outer surface 145 of the compression sleeve receiving section 142, causing the compression sleeve receiving section 142 to be forced inward. As this occurs, the internal broached ribs or grip ribs 143 dig into the outer shield member 172 of the cable 112, thereby enhancing the electrical and mechanical connection between the outer shield member 172 and the housing 114, and preventing the unwanted removal of the cable 112 from the connector assembly 110.

The connector assembly 110 terminates the coaxial cable 112 to a printed circuit board without the need of a separable interface on the coaxial cable 112, thereby reducing the space required on and around the printed circuit board and improving the electrical performance while reducing cost. In addition, the connector assembly 110 can be disassembled and reassembled to allow for repair or replacement of the cable as needed.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A connector assembly for mounting a coaxial cable to a substrate without the need of a separable interface, the connector assembly comprising:
a housing having a cable receiving end and a substrate mating end, the cable receiving end positioned in a first plane and the substrate mating end positioned in a second plane, the first plane being substantially transverse to the second plane;
a cable receiving passage being positioned in the housing, cable receiving passage extending from the cable receiving end;
a center terminal extending through the substrate mating end, a conductor terminating portion of the center terminal extending into the cable receiving passage, the conductor terminating portion configured to make a mechanical and electrical engagement with a center conductor of the coaxial cable.

2. The connector assembly as recited in claim 1, wherein the housing is made of electrically conductive material, a cable positioning wall of the housing extends into a cable receiving passage of the housing, a center conductor receiving opening extends through the cable positioning wall.

3. The connector assembly as recited in claim 1, wherein a terminal receiving opening extends through a bottom portion of the housing, the terminal receiving opening extends into the cable receiving passage.

4. The connector assembly as recited in claim 3, wherein the center terminal has a longitudinal axis which is positioned essentially perpendicular to a longitudinal axis of the cable receiving passage.

5. The connector assembly as recited in claim 3, wherein a dielectric insulator member is positioned in the terminal receiving opening to electrically insulate the center terminal from the housing.

6. The connector assembly as recited in claim 1, wherein mounting legs extend from the bottom portion of the housing, the mounting legs are configured to be positioned in through holes or soldered to the surface of the printed circuit board to secure the housing to the printed circuit board.

7. The connector assembly as recited in claim 1, wherein the center terminal has a circuit board mounting portion, a housing mounting portion and a conductor terminating portion.

8. The connector assembly as recited in claim 7, wherein the conductor terminating portion has a bifurcated configuration with a terminal receiving opening and a slot extending to the free end of the conductor terminating portion.

9. The connector assembly as recited in claim 1, wherein a slot extends through a top portion of the housing, the slot extends into the cable receiving passage and is positioned to allow the center terminal to be viewed during assembly of the connector assembly.

10. The connector assembly as recited in claim 9, wherein a removable access hood is configured to be positioned in the slot, the access hood a reduced thickness portion provided at one end thereof, the reduced thickness portion has an opening or viewport which extends therethrough, a securing arm is positioned at the opposite end of the access hood from the reduced thickness portion, the securing arm has first portion and a second portion, the second portion is configured to be positioned in a mounting opening of the housing.

11. The connector assembly as recited in claim 1, wherein a solder sleeve receiving section is provided on the housing at a cable receiving end of the housing.

12. The connector assembly as recited in claim 11, wherein an outer diameter of the solder sleeve receiving section is smaller than the outer diameter of the housing.

13. The connector assembly as recited in claim 1, wherein a solder sleeve is positioned on an solder sleeve receiving section of the housing, a solder receiving channel extends about the circumference of the inner wall of the solder sleeve, the solder receiving channel has solder material positioned therein, an opening or viewport extends through the solder sleeve.

14. The connector assembly as recited in claim 1, wherein the housing has a first portion and a second portion.

15. The connector assembly as recited in claim 14, wherein a compression sleeve receiving section is provided on the housing at a cable receiving end, the compression sleeve receiving section has internal grip ribs which extend about the inner surface of the compression sleeve receiving section.

16. The connector assembly as recited in claim 15, wherein an outer surface of the compression sleeve receiving section is tapered, with the portion of the compression sleeve receiving section proximate the cable receiving end having a smaller diameter than the portion of the compression sleeve receiving section which is spaced from the cable receiving end.

17. The connector assembly as recited in claim 14, wherein a securing arm extends from the first portion of the housing, a section of the securing arm is configured to be positioned a mounting opening positioned in a rear wall of the second portion of the housing.

18. The connector assembly as recited in claim 16, wherein a compression sleeve is positioned on the compression sleeve receiving section of the housing, an inner surface of the compression sleeve is tapered, with the portion of the compression sleeve proximate a leading edge having a larger diameter than the portion of the compression sleeve which is spaced from the leading edge.

19. Method of terminating a connector assembly for mounting a coaxial cable to a substrate without the need of a separable interface, the method comprising;
mounting the connector assembly to a printed circuit board;
inserting the cable with exposed center conductor into a portion of a housing the connector assembly;
engaging the center conductor electrically with a center terminal of the connector assembly;
engaging an outer conductive shield of the cable with a wall of the housing securing the cable in the housing of the connector assembly;
wherein the connector assembly terminates the cable to the printed circuit board without the use of a separable interface positioned on the cable.

20. The method as recited in claim 19 wherein:
the housing of the connector assembly comprising has a cable receiving end and a substrate mating end, the cable receiving end positioned in a first plane and the substrate mating end positioned in a second plane, the first plane being substantially transverse to the second plane;
a cable receiving passage extends from the cable receiving end;
the center terminal extending through the substrate mating end, a conductor terminating portion of the center terminal extending into the cable receiving passage, the conductor terminating portion configured to make a mechanical and electrical engagement with a center conductor of the coaxial cable; and.
the center terminal has a longitudinal axis which is positioned essentially perpendicular to a longitudinal axis of the cable receiving passage.
